(19) United States
(12) Patent Application Publication
(10) Pub. No.: US 2013/0050384 A1
(43) Pub. Date: Feb. 28, 2013

(54) PRINTING APPARATUS AND METHOD

(71) Applicant: Takashi Sugimoto, Shizuoka-ken (JP)

(72) Inventor: Takashi Sugimoto, Shizuoka-ken (JP)

(73) Assignee: TOSHIBA TEC KABUSHIKI KAISHA, Tokyo (JP)

(21) Appl. No.: 13/590,368

(22) Filed: Aug. 21, 2012

(30) Foreign Application Priority Data
Aug. 29, 2011 (JP) 2011-186415

(51) Int. Cl. B41J 2/325

(52) U.S. Cl. 347/218

(57) ABSTRACT

A printing apparatus comprises a conveying section configured to convey a belt-like storing medium in a first conveying direction or a second conveying direction in which opposite to the first conveying direction, a driving section configured to drive the conveying section, a gears configured to transfer the driving force to the conveying section, a cutter section configured to cut off the storing medium when the storing medium is conveyed to a predetermined cutoff position, a printing section configured to print on the storing medium at a upstream position than the cutter section in the first conveying direction and a control section configured to stop the printing and convey the storing medium to the distance of at least gap-distance of the gears in the second conveying direction before the storing medium is cut off, and resume the printing of the printing section after the storing medium is cut off.

### CROSS-REFERENCE TO RELATED APPLICATION:

This application is based upon and claims the benefit of priority from Japanese Patent Application No. 2011-186415, filed Aug. 29, 2011, the entire contents of which are incorporated herein by reference.

### FIELD

Embodiments described herein relate to a printing apparatus and a printing method.

### BACKGROUND

In a thermal printing apparatus equipped with a platen roller for conveying thermal paper, a step motor for driving the platen roller, a print head for printing on the conveyed thermal paper and a cutter for cutting the printed thermal paper into any length, the print head and the cutter are typically separated from each other by a distance in the conveying path of the thermal paper, and preferably, no printing is implemented when the cutoff position (for the cutter to cut off) of the thermal paper is located between the print head and the cutter.

However, implementing no printing when the cutoff position of the thermal paper is located between the print head and the cutter will lead to a wasted blank on the thermal paper, therefore, the following technology is used in the conventional thermal printing apparatus: thermal paper is printed before being cut off by the cutter, that is, thermal paper is printed when the cutoff position of the thermal paper is located between the print head and the cutter, and no longer printed and switched after the cutoff position reaches the position of the cutter, then the switched thermal paper is printed after the former thermal paper is cut off.

### BRIEF DESCRIPTION OF THE DRAWINGS

FIG. 1 is a diagram roughly showing the structure of the printer provided in this embodiment;

FIG. 2 is a block diagram showing the electrical connection of the components of the printer provided in this embodiment;

FIG. 3 is a diagram roughly showing the structure of the display operation unit of the printer provided in this embodiment;

FIG. 4 is a block diagram showing the functional components of the printer provided in this embodiment;

FIG. 5 is a diagram showing an example of a setting screen for setting a first value;

FIG. 6 is a diagram showing an example of a setting screen for setting a second value;

FIG. 7A is a diagram illustrating the gap between a first gear and a second gear before a backfeed is implemented;

FIG. 7B is a diagram illustrating the gap between a first gear and a second gear after a backfeed is implemented;

FIG. 8 is a diagram showing a printed image subjected to the offset caused by the back rotation of a first and second gears in a printing position;

FIG. 9 is a diagram showing a printed image on which the offset caused by the back rotation of a first and second gears in a printing position is corrected;

FIG. 10 is a diagram showing a printed image on which the offset caused by the back rotation of a first and second gears in a printing position is corrected;

FIG. 11 is a flow chart showing the printing flow of the printer provided in this embodiment.

### DETAILED DESCRIPTION

In accordance with an embodiment, a printing apparatus comprises a conveying section configured to convey a belt-like storing medium in a first conveying direction or a second conveying direction in which opposite to the first conveying direction, a driving section configured to drive the conveying section, a gears configured to transfer the driving force of the driving section to the conveying section, a cutter section configured to cut off the storing medium by catching the storing medium therein when the storing medium is conveyed to a predetermined cutoff position, a printing section configured to print on the storing medium at a upstream position than the cutter section in the first conveying direction and a control section configured to stop the printing of the printing section and convey the storing medium to the distance of at least gap-distance of the gears in the second conveying direction before the storing medium is cut off, and convey the storing medium in the first conveying direction and then resume the printing of the printing section after the storing medium is cut off.

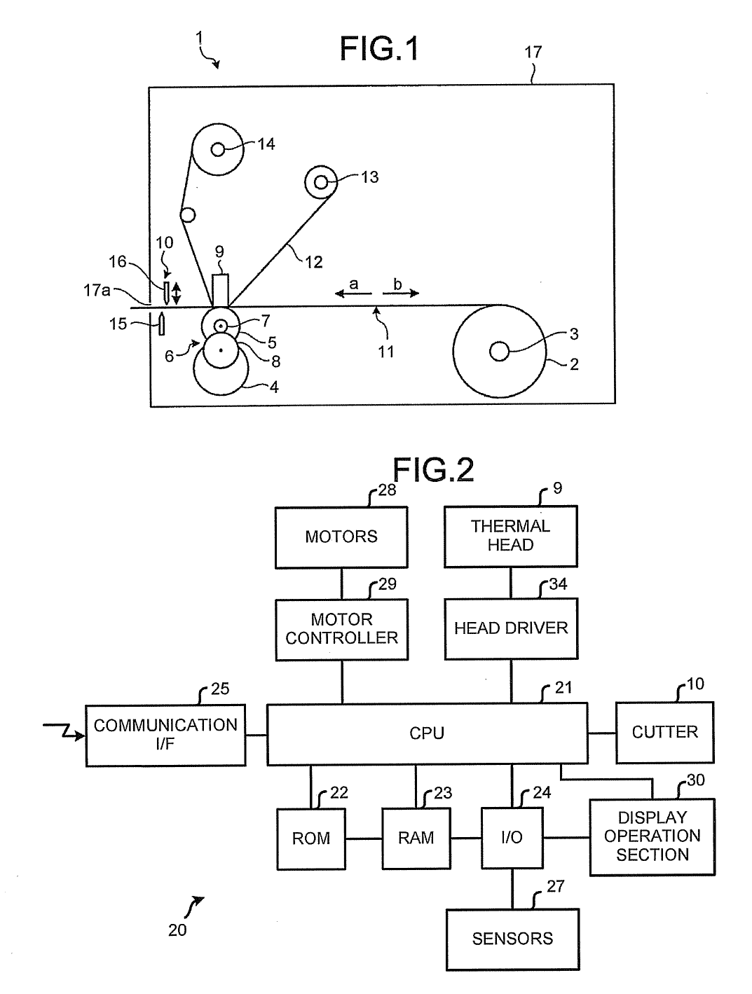

FIG. 1 is a diagram roughly showing the structure of the printer provided in this embodiment. As shown in FIG. 1, the printer 1 (printing apparatus) provided in this embodiment is a receipt printer applied to a POS (Point Of Sales) terminal, a menu order printer for printing a menu order, or a label printer for printing on label paper. In accordance with this embodiment, the printer 1 comprises: a paper holder section 3 for holding paper 2 that serves as a belt-like storing medium; a platen roller 5 for conveying the paper 2 in a first conveying direction a or a second conveying direction b opposite to the first conveying direction a; a step motor 4 serving as a driver section for driving the platen roller 5; a transfer section 6 for transferring the driving force of the step motor 4 to the platen roller 5 by rotating a first gear 7 at the side of the platen roller 5 and a second gear 8 at the side of the step motor 4; a cutter 10 for cutting off the paper 2 by catching the paper 2 therein when the paper 2 is conveyed to a predetermined cutoff position; and a thermal head 9 which is arranged at a upstream position than the cutter 10 as a printing section to print on the paper 2 conveyed in the first conveying direction a.

The thermal head 9 and the platen roller 5 are arranged opposite to each other, thereby forming a paper conveying path 11 there between to convey the paper 2. The thermal head 9 applies a force to the platen roller 5 with a force applying member of a plate spring (not shown). An ink ribbon 12 is hung on the thermal head 9. The ink ribbon 12 is supported in such a state that the two ends of the ink ribbon are coiled on two ribbon cores 13 and 14. The non-used end of the ink ribbon 12 is coiled on the ribbon core 13 while the used end of the ink ribbon 12 on the ribbon core 14. As stated above, the platen roller 5 rotates under the drive of the step motor 4. The rotating platen roller 5 conveys the paper 2 that is clamped with the thermal head 9. That is, the platen roller 5 and the thermal head 9 may also function as a conveying section.

The cutter 10 is a cutter-type cutoff section equipped with a fixed blade 15 and a movable blade 16 that are arranged at two sides of the paper conveying path 11 for conveying the paper 2. By moving the movable blade 16 upwards in the vertical direction shown in FIG. 1 with respect to the fixed blade 15, the cutter 10 sandwiches the paper 2 between the fixed blade 15 and the movable blade 16 and then cuts off the paper 2. Moreover, in this embodiment, the cutter 10 is a cutter-type cutoff section, however, the present invention is not limited to this, a cutter of roller type or another type may also be used as the cutter 10 as long as the cutter can cut off the paper 2 by catching the paper 2 between the fixed blade 15 and the movable blade 16.

In the printer 1 with the structure above, the paper 2 is conveyed by the rotating platen roller 5 when sandwiched between the thermal head 9 and the platen roller 5, and the thermal head 9 prints on the paper 2 during the conveying process. The printing ink coated on the ink ribbon 12 is melted by heating the right ones of the heating elements arranged in the thermal head 9. The melted printing ink is transferred onto the paper 2 to print on the paper 2. The printed paper 2 is cut off by the cutter 10 and then released from a release port 17a formed on the housing 17 of the printer 1. The actions above are carried out by the under-mentioned control section 20 (refer to FIG. 2) which controls the thermal head 9, the platen roller 5 and the cutter 10.

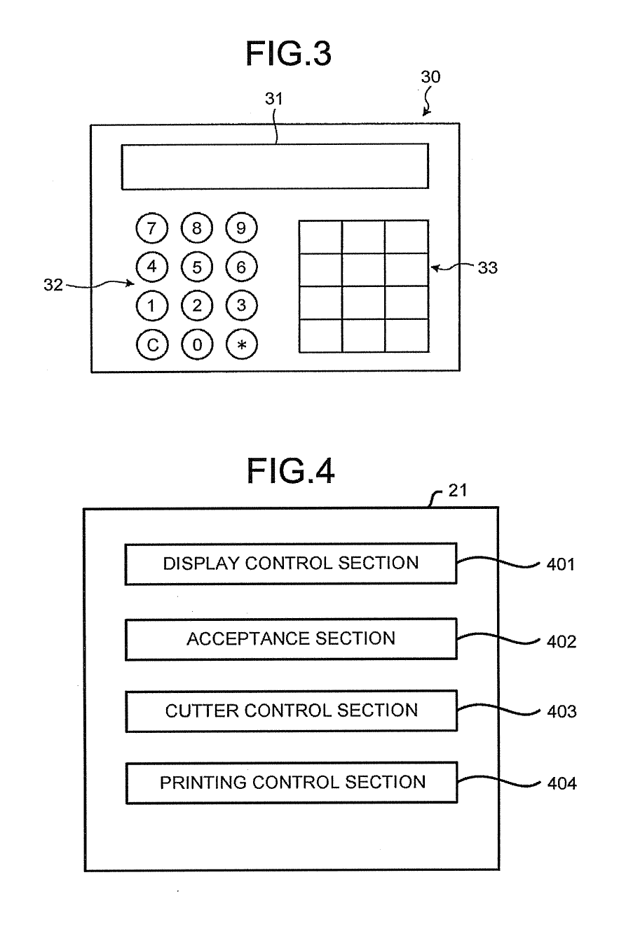

FIG. 2 is a block diagram showing the electrical connection of the components of the printer provided in this embodiment. FIG. 3 is a diagram roughly showing the structure of the display operation unit of the printer provided in this embodiment. The printer 1 comprises a control section 20, which is equipped with a CPU (Central Processing Unit) 21, an ROM (Read Only Memory) 22, an RAM (Random Access Memory) 23, an I/O port 24 consisting of an input port for acquiring information at the side of the CPU 21 and an output port for sending information from the CPU 21 to the outside (each section of the printer), and a communication interface 25 for exchanging the printing data (printing image), the cutoff indication data from an upper device and the other necessary data, the components of the control section 20 are connected with each other via a bus line. Moreover, various sensors 27 are connected with the I/O port 24.

Various programs and data are stored in the ROM 22 in advance. The RAM 23 serves as a working area for the CPU 21 to execute various programs. Moreover, the RAM 23 makes a backup using a battery and is equipped with a printing buffer and a character generator. Further, the CPU 21 is connected, via a bus line, with a head driver 34 for controlling the thermal head 9, a motor controller 29 for controlling the cutter 10 and various motors (step motor 4) and a display operation section 30 for displaying various information for the operator of the printer 1 and inputting various operation information for the printer 1. The CPU 21 executes the programs stored in the ROM 22 to control each of the sections above. Further, as shown in FIG. 3, the display operation section 30 has an LCD (Liquid Crystal Display) 31 serving as a display section for displaying various information, a numeric keypad 32 and keys 33 for selecting a setting menu that is set on the printer 1.

FIG. 4 is a block diagram showing the functional components of the printer provided in this embodiment. By executing the programs stored in the ROM 22, the CPU 21 of the printer 1 provided in this embodiment achieves the functions of a display control section 401, an acceptance section 402, a cutter control section 403 and a printing control section 404.

The display control section 401 controls the LCD 31 of the display operation section 30 to display various kinds of information. Specifically, the display control section 401 displays a setting screen for setting a first value or second value according to the selection on a setting menu that is achieved by operating the keys 33, wherein the first value is set to stop the printing of the thermal head 9 and convey (backward feed) the paper 2 in the second conveying direction b before the paper 2 is cut off by the cutter 10, and the second value is set to convey (forward feed) the paper 2 in the first conveying direction a after the cutter 10 cuts off the paper 2.

Here, the first value which is set to stop the printing of the thermal head 9 and convey the paper 2 in the second conveying direction b before the paper 2 is cut off is at least as great as the gap between the first gear 7 and the second gear 8, and the second value which is set to convey the paper 2 in the first conveying direction a after the paper is cut off refers to a value smaller than the first value. In this embodiment, the first value and the second value are represented by the number of the steps needed to drive the step motor 4.

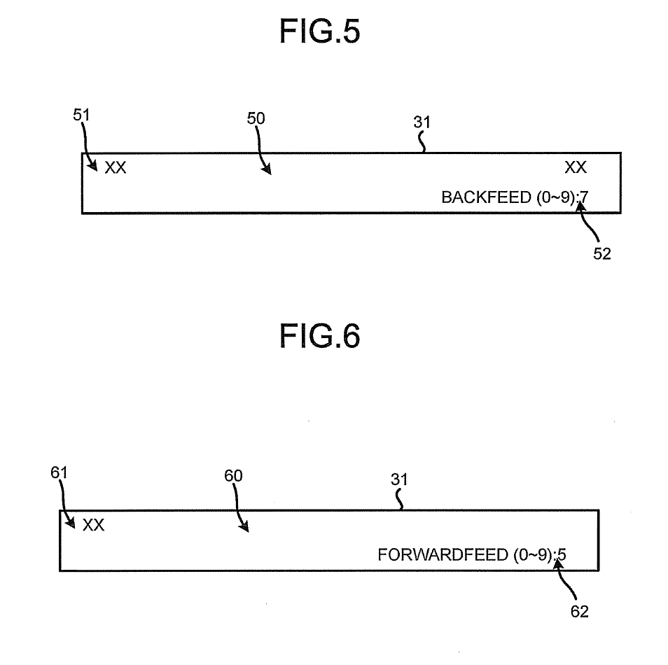

FIG. 5 is a diagram showing an example of a setting screen for setting the first value. In this embodiment, the display control section 401 displays the setting screen 50 shown in FIG. 5 when the setting menu for setting the first value is selected by operating keys 22. A menu number 51 for specifying the setting menu selected by operating the keys 33, and the first value 52, that is, the number of the steps executed by the step motor 4 for feeding back the paper 2, are displayed on the setting screen 50. Moreover, in this embodiment, the first value 52, which is initially set to be 7, is ranged from 0 to 9.

FIG. 6 is a diagram showing an example of a setting screen for setting the second value. In this embodiment, the display control section 401 displays the setting screen 60 shown in FIG. 6 when the setting menu for setting the second value is selected by operating keys 33. A menu number 61 for specifying the setting menu selected by operating the keys 33, and the second value 62, that is, the number of the steps executed by the step motor 4 to feed the paper 2 forward, are displayed on the setting screen 60. Moreover, in this embodiment, the first value 62, which is initially set to be 7, is ranged from 0 to 9.

Return to FIG. 4, the acceptance section 402 accepts the settings set by the display control section 401 on the setting screen displayed on the LCD 31. Specifically, the acceptance section 402 accepts the first value set on the setting screen 50 and the second value set on the setting screen 60. Moreover, in this embodiment, the acceptance section 402 accepts the values below the first value as the second value.

The cutter control section 403 controls the cutter 10 to cut off the paper 2 when the predetermined cutoff position shown by the cutoff indication data that is sent from an upper device through the communication interface 25 reaches the cutter 10 or when the border (the predetermined cutoff position) of a continuously printed image reaches the cutter 10.

The printing control section 404 reads the printing image that is received from the upper device through the communication interface 25 and stored in the RAM 23. Then, the printing control section 404 controls, using the motor controller 29 and the head driver 34, the platen roller 5 and the thermal head 9 to print the printing image on the conveyed paper 2. Moreover, in the case where a plurality of printing images are received from the upper device, the printing control section 404 prints a printing image on the paper 2, and then continues to enable the printing of the thermal head 9 before the predetermined cutoff position of the paper 2 passing the thermal head 9 reaches the cutter 10. That is, if a plurality of printing images are received, the printing control section 404 successively prints the received printing images on the paper 2. In this way, after receiving a plurality of printing images, the printer 1 may print the printing images without setting a useless blank row on the paper 2.

Further, when the cutoff position of the paper 2 reaches the cutter 10, the printing control section 404 stops the printing of the thermal head 9 by the head driver 34, and controls the step motor 4 by the motor controller 29 to backward feed the paper 2 in the second conveying direction b by the first value accepted by the acceptance section 402. After the paper 2 is cut off by the cutter 10, the printing control section 404 controls the step motor 4 by the motor controller 29 to feed the paper 2 forward in the first conveying direction a by the second value accepted by the acceptance section 402. Thus, the offset is prevented which is caused by the back rotation of the first gear 7 and the second gear 8 in the printing position when the cutter 10 cuts off the paper 2. Moreover, the sliding of the paper 2 from the platen roller 5 caused by the tension of the cutoff paper 2 is prevented, which further avoids an offset in the new printing position.

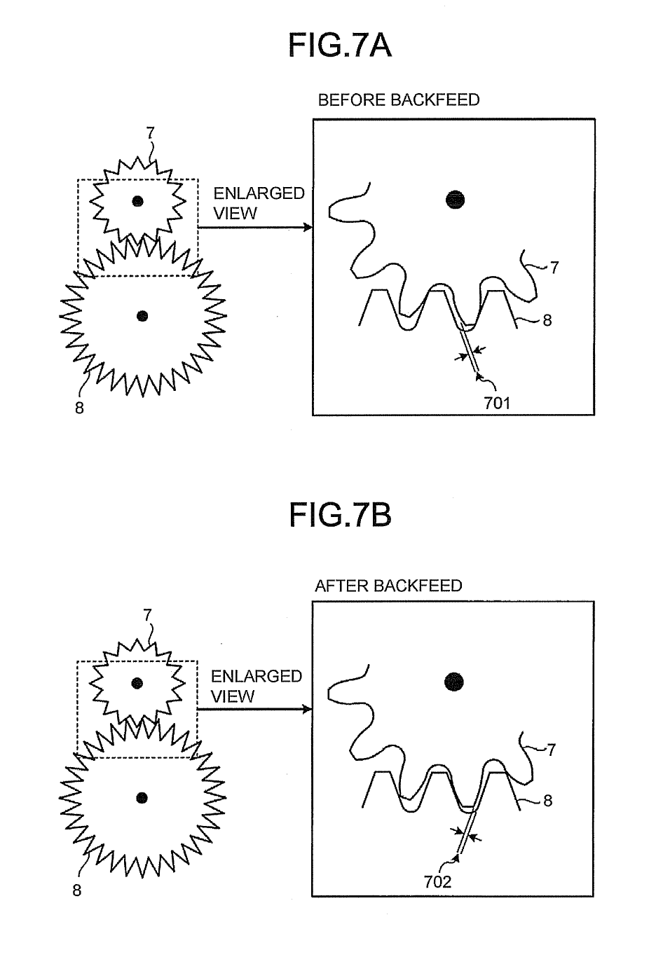

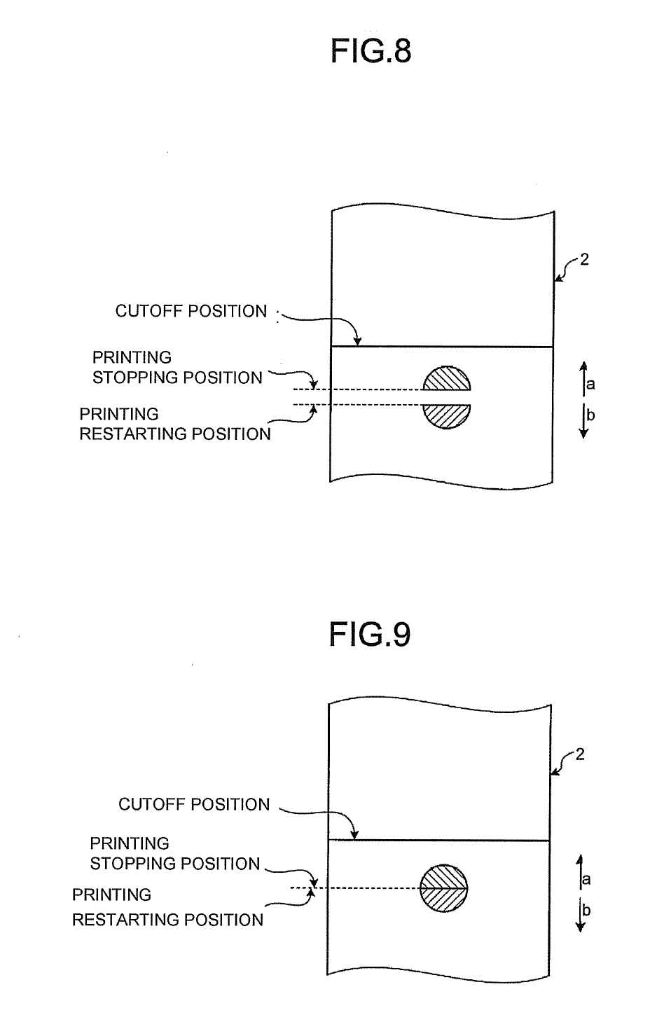

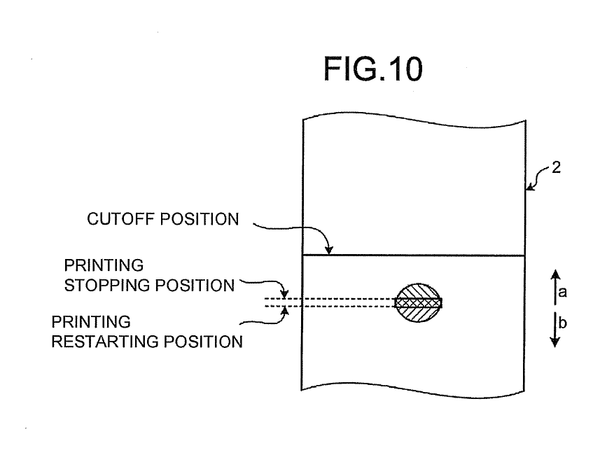

Here, the actions for preventing the offset caused by the back rotation of the first gear 7 and the second gear 8 in a printing position are described in detail below with reference to FIG. 7A, FIG. 7 B and FIG. 8-FIG. 10. FIG. 7A is a diagram illustrating the gap between the first gear and the second gear before a backward feed is implemented. FIG. 7B is a diagram illustrating the gap between the first gear and the second gear after a backward feed is implemented; FIG. 8 is a diagram showing a printed image subjected to the offset caused by the back rotation of the first and second gears in a printing position. FIG. 9 and FIG. 10 are diagrams showing printed images on which the offset caused by the back rotation of the first and second gears in a printing position is corrected.

In printing on the paper 2 using the thermal head 9, the printing control section 404 controls the step motor 4 to rotate the second gear 8 clockwise and the first gear 7 anticlockwise to convey the paper 2 in the first conveying direction a. Moreover, if the cutoff position of the paper 2 reaches the cutter 10, the printing control section 404 stops the rotation of the second gear 8 and the first gear 7 by stopping the step motor 4.

Here, as shown in FIG. 7A, a gap 701 is generated between the first gear 7 and the second gear 8 in the clockwise direction of the first gear 7. Generally, after the step motor 4 is stopped, the teeth of the first gear 7 is biased in the forward (clockwise direction) or the backward (anticlockwise direction) with respect to teeth of the second gear 8, that is to say, a so-called backlash is occurred. When the first gear is in the back rotation state (that is, when the gap 701 is generated), if the cutter 10 cuts off the paper 2, then the paper 2 is pulled in the first conveying direction to shift to the first conveying direction by the gap 701. Moreover, if the paper 2 has a strong tension when cut off by the cutter 10, the platen roller 5 cannot rotate, resulting in that the paper 2 on the platen roller 5 slides towards the first conveying direction a, and sometimes in a significant shift of the paper 2 to the first conveying direction a. When printing is restarted after the paper is cut off, the offset of the paper 2 caused by the cutoff of the cutter 10 will lead to a blank row between the position where the printing is stopped before the paper 2 is cut off and the position where the printing is restarted after the paper 2 is cut off, as shown in FIG. 8.

Therefore, in the conventional printer, no printing is implemented to the part of the paper 2 between the cutter 10 and the thermal head 9, and printing is started from the position of the thermal head 9 immediately the paper is cut off. However, no printing on the part of the paper 2 between the cutter 10 and the thermal head 2 leads to a residual blank part, resulting in the waste on the paper 2.

Therefore, the next printing image is printed before the cutoff position of the paper 2 passing the thermal head 9 reaches the cutter 10, the paper 2 is cut off at the moment the cutoff position of the paper 2 reaches the cutter 10, and then the printing is continued, thus giving rise to a requirement on no needless blank par, however, in the method above, if no consideration is taken into the offset caused by the backfeed in the first conveying direction a, a blank row (refer to FIG. 8) will be generated at the connection position of a printing stopping position and a printing re-starting position when printing is restarted, as stated above.

Therefore, in this embodiment, before the paper 2 is cut off, the printing control section 404 controls the step motor 4 to rotate the second gear 8 anticlockwise and the first gear 7 clockwise, thereby feeding back the paper 2 in the second conveying direction b by at least the gap 701 (the first value). For instance, if three steps are executed to stop the step motor 4 after the cutoff position of the paper reaches the cutter 10, the printing control section 404 executes more than three steps (e.g. five steps) to drive the stop motor 4 to feed the paper 2 back in the second conveying direction b.

As a result, a gap 702 is generated on the first gear 7 in the anticlockwise direction of the first gear 7, as shown in FIG. 7B. In this case, the cutter 10 replaces the paper 2 to pull the paper 2 in the first conveying direction a, the first gear 7 rotates anticlockwise by means of the gap 702 to convey the paper 2 in the first conveying direction a using the platen roller 5. That is, when cut off by the cutter 10, the paper 2 is conveyed in the first conveying direction a by the length at which the paper 2 is conveyed in the second conveying direction b before being cut off by the cutter 10. In this way, the printing stopping position of the paper 2 is prevented from passing the thermal head 9 to avoid an undesired conveying of the paper 2, thus preventing the generation of a blank row.

Moreover, if the paper 2 undergoes a great tension when being cut off by the cutter 10, the first gear 7 rotates anticlockwise by means of the gap 702 to convey the paper 2 in the first conveying direction a with the platen roller 5. In this way, the sliding of the paper 2 on the platen roller 5 towards the first conveying direction a as well as the conveying of the paper 2 resulting from the passing of the printing stopping position of the paper 2 through the thermal head 9 is prevented, thus preventing the generation of a blank row. That is, as shown in FIG. 9, the position where the printing on the paper 2 that is not cut off is stopped and the position where printing is restarted after the paper 2 is cut off are substantially overlapped.

Moreover, if the paper 2 sandwiched by the cutter 10 undergoes a tension that is greater than the excitation inhibition of the platen roller 5 or the surface of the paper 2 slides out easily, that is, if the paper 2 is fed back before being cut off, a physical error such as the sliding of the paper 2 out of the platen roller 5 in the first conveying direction a occurs as well. Therefore, the printing control section 404 feeds the paper 2 forward by the second value (a value below the first value) which is calculated by taking into consideration the physical error caused by the tension of the paper 2 that is greater than the excitation inhibition of the platen roller 5 and the surface flatness of the paper 2.

For instance, the printing control section 404 executes more than three steps (e.g. five steps) to drive the step motor 4 to backward feed the paper 2 in the second conveying direction b to cut off the paper 2. Moreover, after the paper 2 is cut off, the printing control section 404 executes several steps that are less than those executed to backward feed the paper 2 (that is, three steps) to drive the step motor 4 to feed the paper 2 forward in the first conveying direction a. In this way, the shift of the paper 2 to the first conveying direction a caused by a physical error is prevented.

After the paper 2 is cut off, the printing control section 404 drives the step motor 4 by executing the steps equal in number to the backward feed steps (that is, five steps) to feed the paper 2 forward in the first conveying direction a. Moreover, in this embodiment, the printing control section 404 drives the step motor 4 by the second value that is equal or (or smaller than) the first value to feed the paper 2 forward in the first conveying direction a, however, the present invention is not limited to this. The printing control section 404 may also drive the step motor 4 by a second value greater than the first value to convey the paper 2 in the first direction a. In this way, although the position where the printing on the paper 2 that is not cut off is stopped and the position where printing is restarted after the paper 2 is cut off are not the same, the generation of a blank row between the two positions is prevented, as shown in FIG. 8.

Besides, in this embodiment, the printing control section 404 feeds the paper 2 back or forward by the first or second value accepted by the acceptance section 402, however, the present invention is not limited to this. For instance, the first and second values, which are calculated by taking into consideration the mechanical error caused by the wear of the first gear 7 and the second gear 8 resulting from years of degradation and the reduction in the excitation intensity of the platen roller 5 resulting from years of degradation, may be stored in a non-volatile memory such as a flash ROM, and the printing control section 404 feeds the paper 2 back or forward according to the first or second value stored in the non-volatile memory.

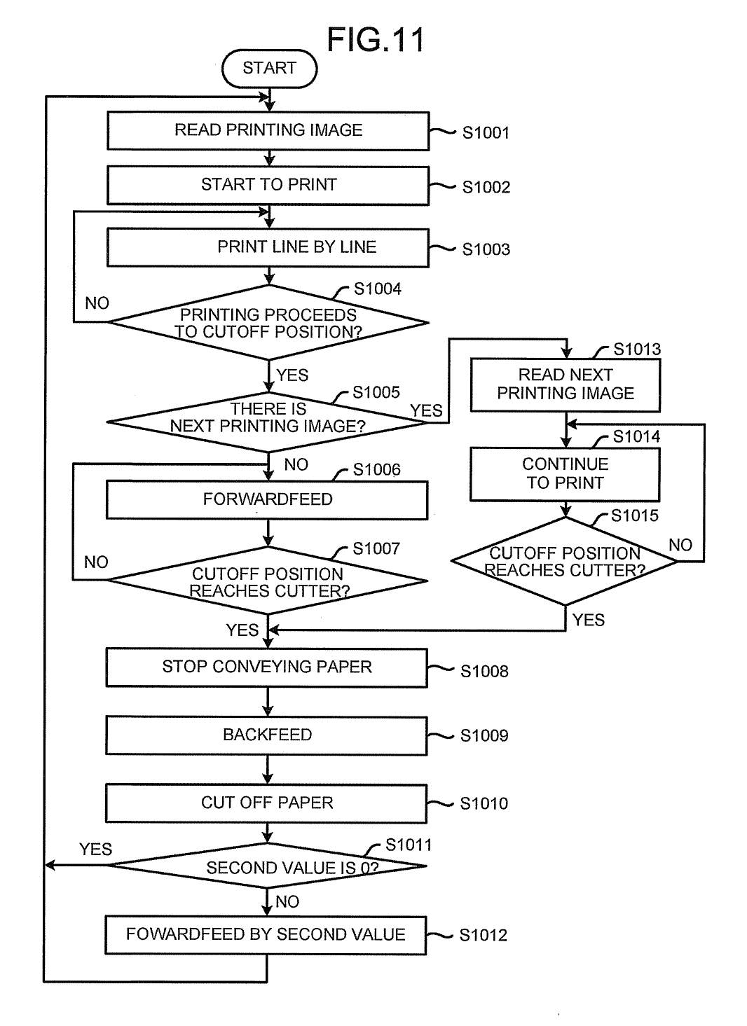

The printing flow of the printer 1 provided in this embodiment is described below with reference to FIG. 11. FIG. 11 is a flow chart showing the printing flow of the printer provided this embodiment.

The printing control section 404 reads the printing images that are received from an upper device and then stored in a memory medium such as the RAM 23 (Act S1001). Next, the printing control section 404 controls the platen roller 5 and the thermal head 9 to start to print the read printing images (Act S1002). The printing control section 404 sends the printing image of each line to the thermal head 9 to print on the paper 2 line by line (Act S1003). Further, the printing control section 404 determines whether or not the predetermined cutoff position of the paper 2 is reached (Act S1004) every time a line is printed. If the cutoff position is not reached (Act S1004: No), the printing control section 404 returns to execute Act 1003 to continue to print on the paper 2.

On the other hand, if the predetermined cutoff position of the paper 2 is reached (Act S1004: Yes), the printing control section 404 determines whether or not all the printing images are printed (Act S1005). In this embodiment, the printing control section 404 determines whether or not all the printing images are printed according to whether or not there are printing images left in the RAM 23.

Next, the printing control section 404 controls the step motor 4 to feed the paper forward (Act S1006) if all the printing images are printed (Act S1005: No). Then, if the cutoff position of the paper 2 reaches the cutter 10 (Act S1007: Yes), the printing control section controls the step motor 4 to stop the conveying of the paper 2 by the platen roller 5 (Act S1008). Next, the printing control section 404 controls the step motor 4 to feed the paper 2 back by the first value (Act S1009). After the paper 2 is fed back, the cutter control section 403 controls the cutter 10 to cut off the paper 2 (Act S1010). Thereafter, the printing control section 404 determines whether or not the second value is 0 (Act S1011). If it is determined that the second value is 0 (Act S1011: Yes), the printing control section 404 returns to execute Act S1001 to read a new printing image. On the other hand, if it is determined that the second value is not 0 (Act S1011: No), the printing control section 404 controls the step motor 4 to feed the paper 2 forward (Act S1012) by the second value.

On the other hand, if there are printing images to be printed (Act S1005: Yes), the printing control section 404 reads the next printing image to be printed from the RAM 23 (Act S1013). Moreover, the printing control section 404 controls the platen roller 5 and the thermal head 9 to continue to print printing images on the conveyed paper 2 until the cutoff position of the paper 2 reaches the cutter 10 (Act 1014, Act S1015: No). If the cutoff position of the paper 2 reaches the cutter 10 (Act S1015: Yes), the printing control section controls the step motor 4 to stop the conveying of the paper 2 by the platen roller 5 (Act S1008). Then, the printing control section 404 controls the step motor 4 to feed the paper 2 back by the first value (Act S1009). After the paper 2 is fed back, the cutter control section 403 controls the cutter 10 to cut off the paper 2 (Act S1010) Thereafter, the printing control section 404 determines whether or not the second value is 0 (Act S1011). If it is determined that the second value is 0 (Act S1011: Yes), the printing control section 404 returns to execute Act S1001 to read a new printing image. On the other hand, if it is determined that the second value is not 0 (Act S1011: No), the printing control section 404 controls the step motor 4 to feed the paper 2 forward (Act S1012) by the second value.

As stated above, in accordance with this embodiment, the printer 1 comprises: the platen roller 5 arranged to convey the paper 2 in the first conveying direction a or the second conveying direction b opposite to the first conveying direction a; the step motor 4 arranged to drive the platen roller 5; the first gear 7 and the second gear 8 arranged to transfer the driving force of the step motor 4; the cutter 10 arranged to cut off the paper 2 by catching the paper 2 therein when the paper 2 is conveyed to the predetermined cutoff position; the thermal head 9 arranged at a upstream position than the cutter 10 to print on the paper 2 until the cutoff position of the paper 2 reaches the cutter 10; and the printing control section 404 arranged to stop the printing of the thermal head 9 and convey the paper 2 in the second conveying direction b by a distance not shorter than the gap between the first gear 7 and the second gear 8 before the paper 2 is cut off and after the paper 2 is cut off, convey the paper 2 in the first conveying direction a and then restart the printing of the thermal head 9.

Therefore, in the case where the paper 2 is cut off by the cutter 10 and then pulled in the first conveying direction a, the first gear 7 rotates anticlockwise by means of the gap 702 to convey the paper 2 in the first conveying direction using the platen roller 5, thereby preventing the printing stopping position of the paper 2 passing the thermal head 9 to avoid undesired conveying of the paper 2, thus preventing the generation of a blank row caused by the back rotation of the first gear 7 and the second gear 8.

Moreover, in the case where the paper 2 undergoes a great tension when being cut off by the cutter 10, the first gear 7 rotates anticlockwise by means of the gap 702 to convey the paper 2 in the first conveying direction a using the platen roller 5, thereby preventing the sliding of the paper 2 on the platen roller 5 towards the second conveying direction b as well as the conveying of the paper resulting from the passing of the printing stopping position of the paper 2 through the thermal head 9, thus preventing the generation of a blank row.

Further, the programs executed by the printer 1 provided in this embodiment is pre-compiled in an ROM. However, the present invention is not limited to this. The programs executed by the printer 1 in this embodiment may be stored as in a computer-readable storing medium such as CD-ROM, FD (floppy drive), CD-R, DVD (digital versatile disk) as an installable or executable file, or stored in a computer connected with a network such as the Internet to be provided through a network download, or provided or published by a network such as the Internet.

The programs executed by the printer 1 in this embodiment consist of modules including each of the foregoing units (the display control section, the acceptance section, the cutter control section and the printing control section), however, as an actual piece of hardware, a CPU reads the programs from the ROM and then executes the programs to load each of the foregoing units to a main memory to generate the display control section, the acceptance section, the cutter control section and the printing control section on the main memory.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printing apparatus, comprising:
a conveying section configured to convey a belt-like storing medium in a first conveying direction or a second conveying direction in which opposite to the first conveying direction;
a driving section configured to drive the conveying section;
a gears configured to transfer the driving force of the driving section to the conveying section;
a cutter section configured to cut off the storing medium by catching the storing medium therein when the storing medium is conveyed to a predetermined cutoff position;
a printing section configured to print on the storing medium at a upstream position than the cutter section in the first conveying direction; and
a control section configured to stop the printing of the printing section and convey the storing medium to the distance of at least gap-distance of the gears in the second conveying direction before the storing medium is cut off, and convey the storing medium in the first conveying direction and then resume the printing of the printing section after the storing medium is cut off.

2. The printing apparatus according to claim 1, further comprising:
an acceptance section configured to accept the first value and the second value, wherein the first value is a value set to stop the printing of the printing section and convey the storing medium in the second conveying direction before the storing medium is cut off, and the second value is a value set to convey the storing medium in the first conveying direction after the storing medium is cut off, wherein
the control section controls such that stops the printing of the printing section and conveys the storing medium to the distance of the first value in the second direction before the storing medium is cut off, and conveys the storing medium to the distance of the second value in the first conveying direction after the storing medium is cut off, when the cutoff position reaches the cutter section.

3. The printing apparatus according to claim 2, wherein
the acceptance section accepts a value below the first value as the second value.

4. A method for controlling a printing apparatus includes a conveying section configured to convey a belt-like storing medium in a first conveying direction or a second conveying direction in which opposite to the first conveying direction, a driving section configured to drive the conveying section, a gears configured to transfer the driving force of the driving section to the conveying section, a cutter section configured to cut off the storing medium by catching the storing medium therein when the storing medium is conveyed to a predetermined cutoff position and a printing section configured to print on the storing medium at a upstream position than the cutter section in the first conveying direction, comprising:
stopping the printing of the printing section and conveying the storing medium to the distance of at least gap-distance of the gears in the second conveying direction before the storing medium is cut off, and conveying the storing medium in the first conveying direction and then resuming the printing of the printing section after the storing medium is cut off.

5. The method according to claim 4, further comprising:
accepting the first value and the second value, wherein the first value is a value set to stop the printing of the printing section and convey the storing medium in the second conveying direction before the storing medium is cut off, and the second value is a value set to convey the storing medium in the first conveying direction after the storing medium is cut off; and
stopping the printing of the printing section and conveying the storing medium to the distance of the first value in the second direction before the storing medium is cut off, and conveying the storing medium to the distance of the second value in the first conveying direction after the storing medium is cut off, when the cutoff position reaches the cutter section.

6. The method according to claim 5, wherein
the accepting a value below the first value as the second value.
